(19) United States
(12) Patent Application Publication
(10) Pub. No.: US 2023/0318933 A1
(43) Pub. Date: Oct. 5, 2023

(54) CONNECTION CONTROL METHOD, INFORMATION PROCESSING DEVICE, AND NON-TRANSITORY COMPUTER-READABLE RECORDING MEDIUM STORING PROGRAM

(71) Applicant: SEIKO EPSON CORPORATION, Tokyo (JP)

(72) Inventor: Katsuyoshi YAMAGUCHI, Matsumoto-shi (JP)

(73) Assignee: SEIKO EPSON CORPORATION, Tokyo (JP)

(21) Appl. No.: 18/191,179

(22) Filed: Mar. 28, 2023

(30) Foreign Application Priority Data
Mar. 29, 2022 (JP) 2022-053881

(51) Int. Cl. H04L 41/22; H04W 76/10

(52) U.S. Cl. CPC H04L 41/22; H04W 76/10

(57) ABSTRACT

A control method is provided. The control method includes: when an information processing device is in a first connection mode, detecting, by the information processing device, a first display device which accepts a connection request with a preset address, among a plurality of display devices, and transmitting, by the information processing device, a first connection request using the preset address to the first display device; and when the information processing device is in a second connection mode, detecting, by the information processing device, at least one display device connected to a network, among the plurality of display devices, accepting, by the information processing device, an operation of selecting a second display device from among the at least one display device connected to the network, accepting, by the information processing device, an input of an address in the network of the second display device, and transmitting, by the information processing device, a second connection request using the address in the network to the second display device.

The present application is based on, and claims priority from JP Application Serial Number 2022-053881, filed Mar. 29, 2022, the disclosure of which is hereby incorporated by reference herein in its entirety.

### BACKGROUND

### 1. Technical Field

The present disclosure relates to a connection control method, an information processing device, and a non-transitory computer-readable recording medium storing a program.

### 2. Related Art

According to the related art, as a method for connecting to a display device, a method of connecting to a network to which the display device is connected and thus communicating data with the display device is employed.

For example, JP-T-2007-516506 discloses a user interface system of a projection device that identifies the state of a projector on a network, enables at least one projector to be selected, based on the identified state, and transmits data to the selected projector.

However, the projector described in JP-T-2007-516506 can be used by any device connected to the same network as the projector. Therefore, there is a concern about deterioration in security though connection can be easily done.

### SUMMARY

According to an aspect of the present disclosure, a control method for a display system executes: when a first connection mode is set, causing an information processing device to detect a first display device accepting a connection request with a preset address, among a plurality of display devices, and to transmit a first connection request using the preset address to the first display device; and when a second connection mode is set, causing the information processing device to detect a display device connected to a network, among the plurality of display devices, to accept an input of an address in the network of a second display device selected from among the display devices connected to the network, and to transmit a second connection request using the address in the network to the second display device.

According to another aspect of the present disclosure, a connection method for an information processing device executes: when a first connection mode is set, detecting a first display device accepting a connection request with a preset address, and transmitting a first connection request using the preset address to the first display device; and when a second connection mode is set, detecting a display device connected to a network, accepting an input of an address in the network of a second display device selected from among the display devices connected to the network, and transmitting a second connection request using the address in the network to the second display device.

According to still another aspect of the present disclosure, a non-transitory computer-readable recording medium storing a program is provided. The program causes a processor provided in an information processing device to execute: when a first connection mode is set, detecting a first display device accepting a connection request with a preset address, and requesting the first display device to make connection; and when a second connection mode is set, detecting a display device connected to a network, among the plurality of display devices, accepting an input of an address in the network of a second display device selected from among the display devices connected to the network, and requesting the second display device to make connection.

### BRIEF DESCRIPTION OF THE DRAWINGS

FIG. 1 shows the system configuration of a display system.

FIG. 2 is a block diagram showing the configuration of a projector.

FIG. 3 is a block diagram showing the configuration of an information processing device.

FIG. 4 shows an example of an app screen.

FIG. 5 shows an example of the app screen.

FIG. 6 shows an example of the app screen.

FIG. 7 shows an example of the app screen.

FIG. 8 shows an example of the app screen.

FIG. 9 is a flowchart showing operations of the information processing device.

FIG. 10 is a flowchart showing operations of the information processing device.

FIG. 11 is a flowchart showing operations of the projector.

### DESCRIPTION OF EXEMPLARY EMBODIMENTS

An embodiment of the present disclosure will now be described with reference to the accompanying drawings.

1. Description of System Configuration of Display System

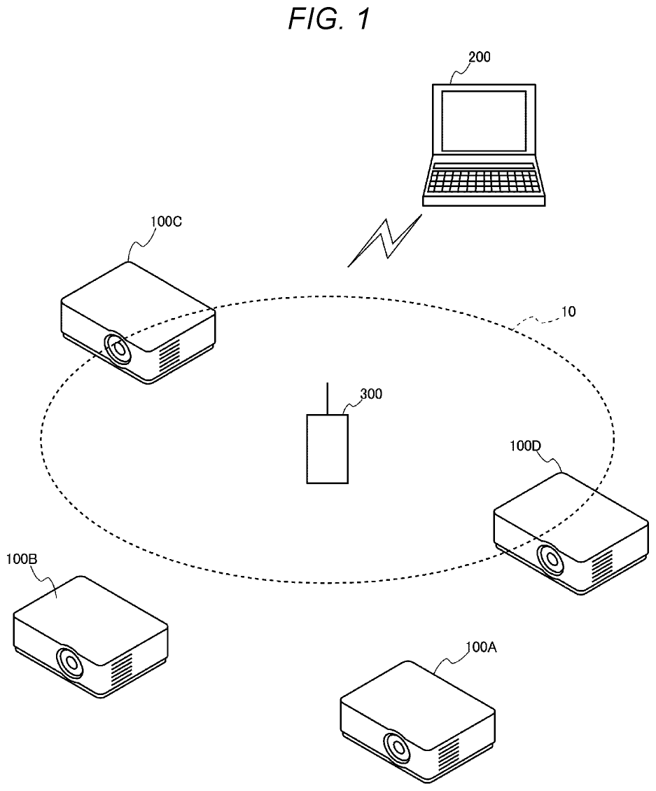

FIG. 1 shows the system configuration of a display system 1.

The display system 1 has a plurality of projectors 100 and an information processing device 200. While one information processing device 200 is illustrated in FIG. 1, any number of information processing devices 200 may be provided in the display system 1. Also, while four projectors 100A, 100B, 100C, and 100D are illustrated in FIG. 1, any number of projectors 100 may be provided. Hereinafter, the projectors 100A, 100B, 100C, and 100D are referred to as the projector 100 when collectively mentioned. The projector 100 is equivalent to a display device.

The information processing device 200 is a device supplying image data that is the source of an image to be projected by the projector 100, to the projector 100. As the information processing device 200, for example, a smartphone, a tablet computer, a laptop computer, or a desktop computer is used.

The projector 100 generates image light corresponding to the image data supplied from the information processing device 200 and displays the generated image light on a projection surface, not illustrated.

The projector 100 and the information processing device 200 are connectable to a wireless network 10 constructed by a wireless router 300 having an access point function. The wireless router 300 relays the transmission and reception of data between devices connected to the wireless network 10.

The wireless router 300 is also connected to a global network such as the internet and relays the transmission and reception of data between a device connected to the global network and a device connected to the wireless network 10. The wireless network 10 is equivalent to a network.

2. Configuration of Projector

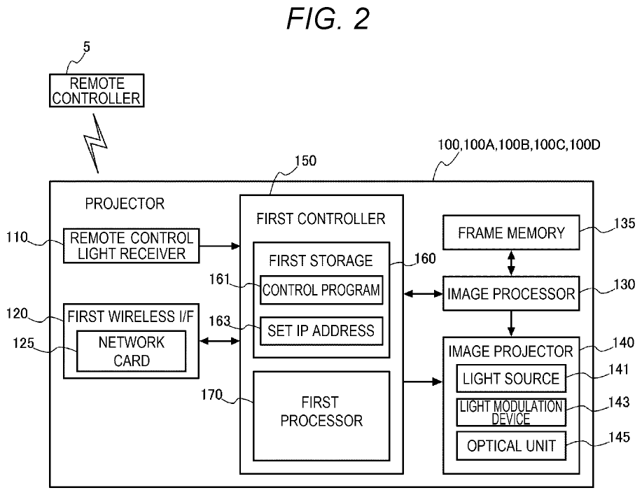

FIG. 2 is a block diagram showing the configuration of the projector 100.

The configuration of the projector 100 will now be described. The projectors 100A, 100B, 100C, and 100D have substantially the same configuration. Therefore, in this example, the configurations of these projectors are described as the configuration of the projector 100. When functions of the projectors 100A, 100B, 100C, and 100D need to be distinguished from each other, symbols “A”, “B”, “C”, and “D” are added in the description. For example, a first storage 160 of the projector 100A is referred to as a first storage 160A, and a first storage 160 of the projector 100B is referred to as a first storage 160B. Also, a first storage 160 of the projector 100C is referred to as a first storage 160C, and a first storage 160 of the projector 100D is referred to as a first storage 160D.

The projector 100 has a remote control light receiver 110, a first wireless interface 120, an image processor 130, a frame memory 135, an image projector 140, and a first controller 150. Hereinafter, the interface is abbreviated as I/F.

The remote control light receiver 110 receives an infrared signal transmitted from a remote controller 5 and outputs an operation signal corresponding to the content of an operation represented by the received infrared signal, to the first controller 150.

The first wireless I/F 120 has a network card 125 and performs wireless communication via a wireless LAN (local area network). The first wireless I/F 120 in this embodiment performs wireless communication via Wi-Fi. Wi-Fi is a registered trademark.

The frame memory 135 is coupled to the image processor 130. The image processor 130 loads image data inputted from the first controller 150 or the first wireless I/F 120 into the frame memory 135. The frame memory 135 is formed of, for example, an SDRAM (synchronous dynamic random-access memory).

The image processor 130 performs image processing such as resolution conversion or resizing, distortion correction, shape correction, digital zoom, or adjustment of the color tone or luminance of the image, on the image data loaded in the frame memory 135. The image processor 130 executes image processing designated by the first controller 150, and performs processing using a parameter inputted from the first controller 150 according to need. Of course, the image processor 130 can also execute a combination of a plurality of types of image processing, of the above image processing. The image processor 130 reads out the image data on which the processing is finished, from the frame memory 135, and outputs the read-out image data to a light modulation device 143 of the image projector 140.

The image processor 130 and the frame memory 135 are formed of, for example, an integrated circuit. The integrated circuit includes an LSI (large-scale integrated circuit), an ASIC (application-specific integrated circuit), a PLD (programmable logic device), an FPGA (field-programmable gate array), an SoC (system-on-a-chip), or the like. An analog circuit may be included in a part of the configuration of the integrated circuit. Also, a configuration where the first controller 150 and the integrated circuit are combined together may be employed.

The image projector 140 has a light source 141, the light modulation device 143, and an optical unit 145.

The light source 141 has a discharge-type light source lamp such as an ultra-high-pressure mercury lamp or a metal halide lamp, or a solid-state light source such as a light-emitting diode or a semiconductor laser. The light emitted from the light source 141 enters the light modulation device 143.

The light modulation device 143 has a light modulation element that modulates the light emitted from the light source 141. The light modulation device 143 has, for example, a transmission-type liquid crystal panel formed of a pair of transparent substrates with a liquid crystal encapsulated therein, as the light modulation element. The liquid crystal panel has a panel area formed of a plurality of pixels arranged in the form of a matrix. The light modulation device 143 applies a drive voltage corresponding to the inputted image data, to each pixel in the panel area, and thus changes the light transmittance of each pixel to the transmittance corresponding to the image data. As the light emitted from the light source 141 is transmitted through the liquid crystal panel, the light is modulated and image light corresponding to the image data is generated.

The light modulation element provided in the light modulation device 143 is not limited to the transmission-type liquid crystal panel and may be, for example, a reflection-type liquid crystal panel or a DMD (digital micromirror device).

The optical unit 145 has a projection lens or the like, not illustrated, and enlarges and projects the image light modulated by the light modulation device 143 onto a projection surface, not illustrated. Thus, an image corresponding to the image light is displayed on the projection surface.

The first controller 150 is a computer device having a first storage 160 and a first processor 170.

The first storage 160 has a non-volatile memory such as a ROM (read-only memory) and a volatile memory such as a RAM (random-access memory). The ROM stores a control program 161 for controlling operations of the projector 100, a set IP (internet protocol) address 163, and various setting information. The set IP address 163 is an IP address in a local network that is set when the projector 100 is shipped from the plant. The set IP address 163 is the IP address of the projector 100 that is used when the projector 100 operates as an access point. The set IP address 163 is equivalent to a preset address. All of a set IP address 163A stored in the first storage 160A of the projector 100A, a set IP address 163B stored in the first storage 160B of the projector 100B, a set IP address 163C stored in the first storage 160C of the projector 100C, and a set IP address 163D stored in the first storage 160D of the projector 100D are the same IP address. The value of the set IP address 163 can be changed by a user's operation. The RAM is used to temporarily store various data or the like.

The first processor 170 is a computational processing device having a processor such as a CPU (central processing unit) or an MPU (micro-processing unit). The first processor 170 may be formed of a single processor or can be formed of a plurality of processors. The first processor 170 may also be formed of an SoC integrated with a part or the entirety of the first storage 160 or another circuit. The first processor 170 may also be formed of a combination of a CPU executing a program and a DSP (digital signal processor) executing predetermined computational processing. Also, all of the functions of the first processor 170 may be installed in hardware or may be configured using a programmable device.

The projector 100 has a first communication mode and a second communication mode, as the communication modes thereof. The first communication mode is a mode in which the set IP address 163 is set to be the address of the network card 125, causing the projector 100 to operate as an access point. When operating in the first communication mode, the projector 100 receives a connection request to the set IP address 163 and directly communicates data with the information processing device 200 that has sent the connection request, without using the wireless router 300. When the projector 100 in the first communication mode has received a connection request to the set IP address 163, the projector 100 permits this connection request.

The second communication mode is a mode in which the projector 100 is connected to the wireless network 10 constructed by the wireless router 300 and communicates data with the information processing device 200 connected to the wireless network 10. The projector 100 sets the IP address set by the wireless router 300 to be the address of the network card 125 and communicates data with the information processing device 200 that has sent the connection request, via the wireless router 300. When the projector 100 in the second communication mode has received a connection request via the wireless network 10, the projector 100 permits this connection request.

The first controller 150 switches the communication mode of the projector 100 to the first communication mode or the second communication mode. Normally, the projector 100 performs communication in the second communication mode. On receiving a change request, the projector 100 changes the communication mode from the second communication mode to the first communication mode.

For example, when the remote control light receiver 110 has received a preset password and a change request to change to the first communication mode, the first controller 150 changes the communication mode from the second communication mode to the first communication mode. Also, when a change request for the communication mode is received from the information processing device 200, the first controller 150 changes the communication mode from the second communication mode to the first communication mode.

3. Configuration of Information Processing Device

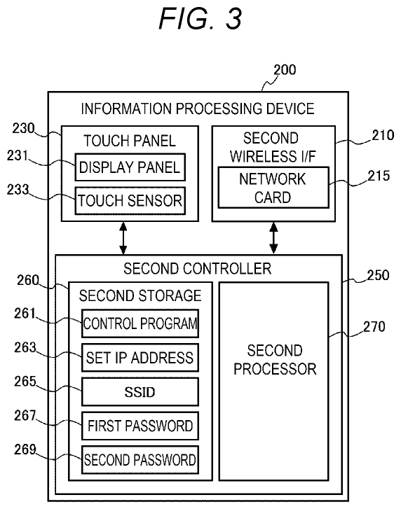

FIG. 3 is a block diagram showing the configuration of the information processing device 200.

The configuration of the information processing device 200 will now be described with reference to FIG. 3.

The information processing device 200 has a second wireless interface 210, a touch panel 230, and a second controller 250.

The second wireless I/F 210 has a network card 215 and performs wireless communication via a wireless LAN. The second wireless I/F 210 in this embodiment performs wireless communication via Wi-Fi.

The touch panel 230 has a display panel 231 and a touch sensor 233 and accepts a user's touch operation. As the display panel 231, for example, a liquid crystal panel or an organic EL (electroluminescence) panel is used. The touch sensor 233 detects the user's touch operation on the display panel 231. The touch sensor 233 outputs information representing the position on the display panel 231 touched by the user, to the second controller 250.

The second controller 250 is a computer device having a second storage 260 and a second processor 270.

The second storage 260 has a non-volatile memory such as a ROM and a volatile memory such as a RAM. The second storage 260 may also be configured having an auxiliary storage device such as an HDD (hard disk drive) or an SSD (solid-state drive).

The RAM is used as an area for computation by the second processor 270. The ROM stores a control program 261 such as an OS (operating system) or an application program, a set IP address 263, an SSID 265, a first password 267, a second password 269, various setting information, and the like. An application program is hereinafter referred to as an app.

The set IP address 263 is the same address as the set IP address 163 stored in the projector 100. The set IP address 263 is equivalent to a preset address.

The SSID 265 and the first password 267 are an SSID and a password that are used when the information processing device 200 is connected to the wireless network 10 constructed by the wireless router 300. The SSID 265 and the first password 267 are set by a user's operation.

The second password 269 is a password set by a system manager and is a password that needs to be entered when changing the communication mode of the projector 100 from the second communication mode to the first communication mode.

The second processor 270 is a computational processing device such as a CPU or an MPU. The second processor 270 may be formed of a single processor or can be formed of a plurality of processors. The second processor 270 may also be formed of an SoC integrated with a part or the entirety of the second storage 260 or another circuit. The second processor 270 may also be formed of a combination of a CPU executing a program and a DSP executing predetermined computational processing. Also, all of the functions of the second processor 270 may be installed in hardware or may be configured using a programmable device.

The second controller 250 executes an app included in the control program 261 and thus connects the information processing device 200 to the projector 100. The information processing device 200 has a first connection mode and a second connection mode, as the connection modes for connecting to the projector 100.

The first connection mode is a mode in which the information processing device 200 accesses the projector 100 accepting a connection request with an IP address corresponding to the set IP address 263 and directly communicates with this projector 100. The connection request based on the set IP address 263 is referred to as a first connection request.

The second connection mode is a mode in which the information processing device 200 wirelessly connects to the wireless network 10 constructed by the wireless router 300 and communicates data with the projector 100 connected to the wireless network 10. To connect to the wireless network 10, the SSID 265 and the first password 267 are used. The information processing device 200 sets an IP address set by the wireless router 300 to be the address of the network card 215 and communicates data with the projector 100 connected to the wireless network 10. The IP address set by the wireless router 300 is equivalent to an address in a network. The connection request based on the IP address set by the wireless router 300 is referred to as a second connection request.

When an app is selected by a touch operation on the touch panel 230, the second controller 250 starts operating under the control of the selected app.

In the description below, it is assumed that the projectors 100A and 100B operate in the first communication mode and that the projectors 100C and 100D operate in the second operation mode. The projectors 100A and 100B are equivalent to a first display device. The projectors 100C and 100D are equivalent to a second display device.

When the connection mode is set to be the first connection mode, the second controller 250 accesses the projector 100 in the first communication mode and acquires the identification information of the projector 100. The projector 100 in the first communication mode is the projector 100 accepting a connection request with an IP address corresponding to the set IP address 263. The identification information is, for example, the name of the projector 100 set by the user or the serial number of the projector 100.

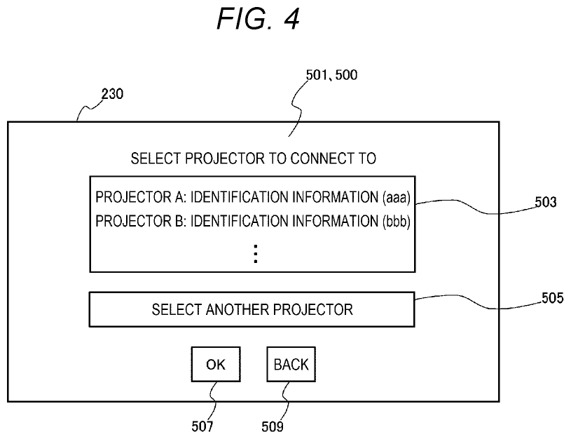

FIG. 4 shows an example of an app screen 500 displayed on the touch panel 230.

FIG. 4 shows an example of a first app screen 501. The first app screen 501 is included in the app screen 500 and is equivalent to a first screen.

On the first app screen 501, a display field 503, a selection field 505, an OK button 507, and a back button 509 are displayed.

In the display field 503, the identification information acquired from the projector 100 in the first communication mode, such as the name of the projector 100 or the serial number of the projector 100, is displayed. In the display field 503 shown in FIG. 4, the identification information of the projectors 100A and 100B operating in the first communication mode is displayed.

The selection field 505 is selected to select a projector 100 other than the projector 100 in the first communication mode.

The OK button 507 is a button pressed to finalize an accepted operation.

The back button 509 is a button to cancel an operation accepted immediately before.

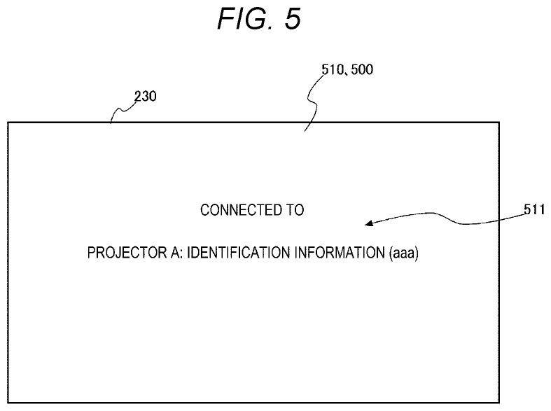

FIG. 5 shows an example of the app screen 500 displayed on the touch panel 230.

FIG. 5 shows a finalization screen 510 displayed when the OK button 507 is pressed after one of the projectors 100 whose identification information is displayed in the display field 503 is selected. The finalization screen 510, too, is included in the app screen 500.

When the projector 100A or 100B whose identification information is displayed in the display field 503 is selected by a touch operation, the second controller 250 transmits a connection request to the selected projector 100A or 100B and wirelessly connects to the selected projector 100A or 100B. The information processing device 200 is directly connected to the projector 100A or 100B operating as an access point. On the finalization screen 510, a guide indication 511 notifying that the information processing device 200 has been connected to the projector 100A or 100B is displayed. The guide indication 511 includes the identification information of the wirelessly connected projector 100A or 100B.

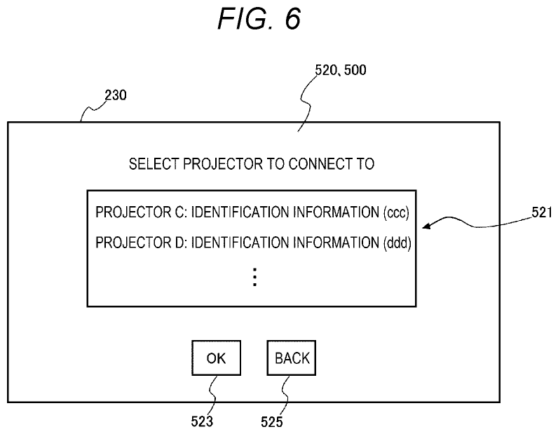

FIG. 6 shows an example of the app screen 500.

FIG. 6 shows an example of a second app screen 520 displayed when the OK button 507 is pressed after the selection field 505 displayed on the first app screen 501 in FIG. 4 is selected. The second app screen 520 is included in the app screen 500 and is equivalent to a second screen.

When the selection field 505 is selected and the OK button 507 is pressed, the second controller 250 connects the information processing device 200 to the wireless network 10 and acquires the identification information of the projector 100 connected to the wireless network 10. The identification information acquired at this point, too, is, for example, the name of the projector 100 set by the user or the serial number of the projector 100.

The second controller 250 then displays the second app screen 520 including the acquired identification information, on the touch panel 230.

On the second app screen 520, a display field 521, an OK button 523, and a back button 525 are displayed.

The OK button 523 and the back button 525 have the same functions as the OK button 507 and the back button 509 displayed on the first app screen 501.

In the display field 521, the identification information of the projector 100 in the second communication mode, that is, the projector 100 connected to the wireless network 10, is displayed.

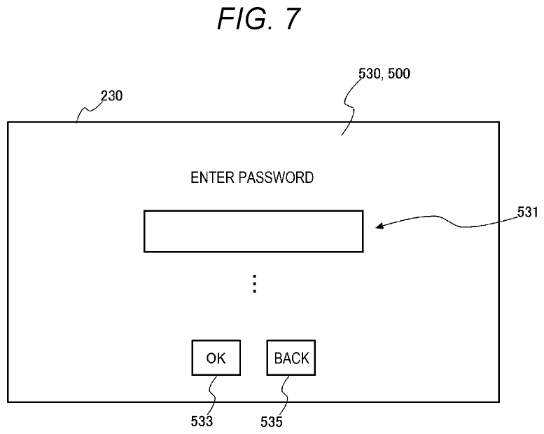

FIG. 7 shows an example of the app screen 500.

FIG. 7 shows an example of a request screen 530 for requesting the entry of a password.

When the projector 100C or 100D whose identification information is displayed in the display field 521 shown in FIG. 6 is selected by a touch operation and the OK button 523 is pressed, the second controller 250 displays the request screen 530 shown in FIG. 7, on the touch panel 230.

On the request screen 530, an entry field 531, an OK button 533, and a back button 535 are displayed. The OK button 533 and the back button 535 have the same functions as the OK button 507 and the back button 509 displayed on the first app screen 501.

When a password is entered in the entry field 531 by a touch operation, the second controller 250 determines whether the entered password coincides with the second password 269 or not. When the entered password does not coincide with the second password 269, the second controller 250 requests the entry of a password again.

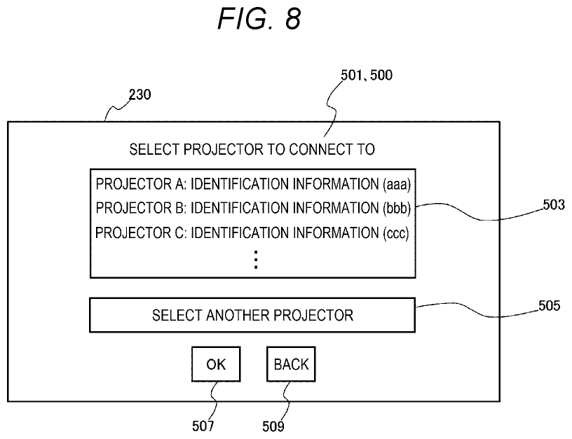

FIG. 8 shows an example of the app screen 500.

FIG. 8 shows the first app screen 501 displayed on the touch panel 230 when the password entered on the request screen 530 shown in FIG. 7 coincides with the second password 269.

When the entered password coincides with the second password 269, the second controller 250 transmits a change request to change the communication mode from the second communication mode to the first communication mode, to the projector 100C or 100D selected on the second app screen 520 shown in FIG. 6.

On receiving a change notification notifying that the communication mode is changed from the second communication mode to the first communication mode from the projector 100C or 100D to which the change request is transmitted, the second controller 250 displays the first app screen 501 shown in FIG. 8. On this first app screen 501, the identification information of the projector 100C or 100D from which the change notification is received is displayed.

When the identification information of the projector 100C or 100D from which the change notification is received is selected by the user and the OK button 507 is pressed, the second controller 250 transmits a connection request to the selected projector 100C or 100D. Thus, the information processing device 200 and the projector 100C or 100D operating in the first communication mode are wirelessly connected to each other.

Operations in the case where the connection mode of the information processing device 200 is set to be the second connection mode will now be described.

When the connection mode is set to be the second connection mode, the second controller 250 first connects to the wireless network 10, using the SSID 265 and the first password 267. The second controller 250 acquires the identification information of the projector 100 connected to the wireless network 10.

After acquiring the identification information of the projector 100 connected to the wireless network 10, the second controller 250 displays the second app screen 520 shown in FIG. 6, on the touch panel 230.

When the projector 100C or 100D whose identification information is displayed in the display field 521 is selected by a touch operation and the OK button 523 is pressed, the second controller 250 displays the IP address entry screen and requests the entry of the IP address.

When the IP address is entered, the second controller 250 transmits a connection request to the selected projector 100 and wirelessly connects to the selected projector 100.

The projector 100 may also change the communication mode from the second communication mode to the first communication mode in the following case.

For example, the projector 100 changes the communication mode from the second communication mode to the first communication mode only for the duration of a set time period for which a conference or the like is scheduled. The schedule of the conference or the like may be set, for example, by operating the remote controller 5. Also, a conference schedule generated by the information processing device 200 may be transmitted to the projector 100.

As the communication mode of the projector 100 is temporarily changed from the second communication mode to the first communication mode only for the duration of a set time period in this way, an easy connection to the projector 100 and a connection where security is maintained can be both implemented. Thus, the convenience for the user can be improved.

4. Operations of Information Processing Device

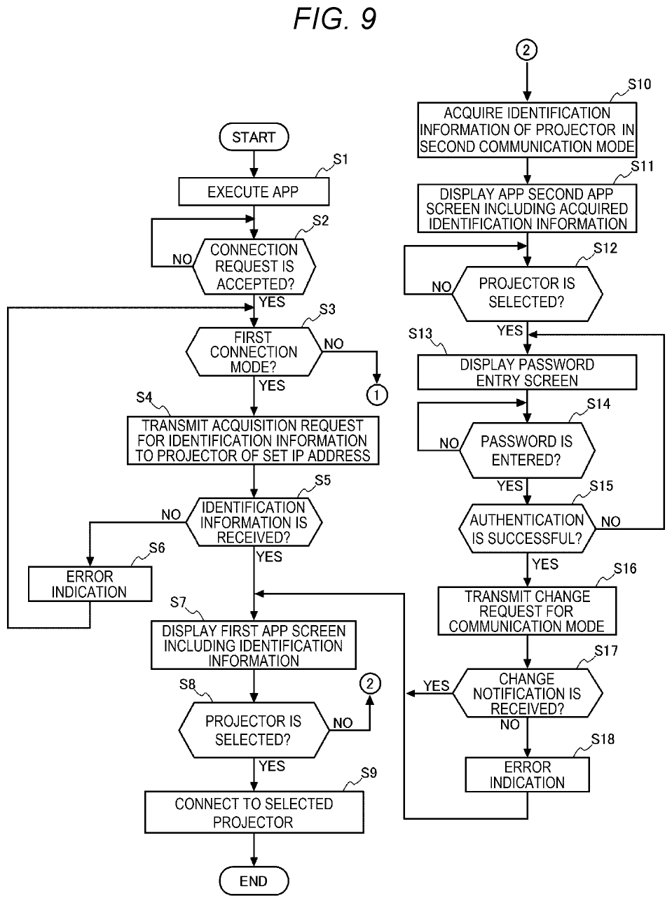

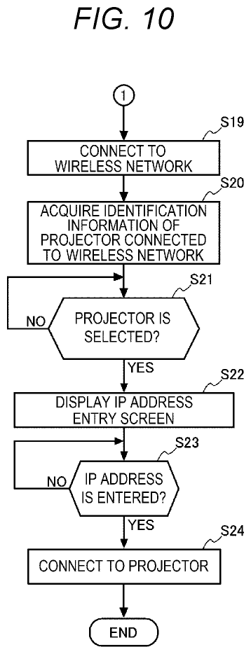

FIGS. 9 and 10 are flowcharts showing operations of the information processing device 200.

The operations of the information processing device 200 will now be described with reference to the flowcharts shown in FIGS. 9 and 10.

When an app is selected by the user via a touch operation, the second controller 250 executes the selected app and starts operating under the control of the app (step S1).

First, the second controller 250 determines whether a connection request to connect to the projector 100 is accepted or not (step S2). When the connection request is not accepted (NO in step S2), the second controller 250 waits until the connection request is accepted.

When the connection request is accepted (YES in step S2), the second controller 250 determines whether the first connection mode is selected as the connection mode or not (step S3). Operations of the second controller 250 in the case where the second connection mode is selected as the connection mode will be described with reference to the flowchart shown in FIG. 10.

When the first connection mode is selected, the second controller 250 transmits an acquisition request for identification information to the projector 100 of the IP address corresponding to the set IP address 263 (step S4). The second controller 250 then determines whether the identification information is received from the projector 100 or not (step S5).

When the identification information is not received from the projector 100 (NO in step S5), the second controller 250 displays an error indication on the touch panel 230 (step S6) and returns to step S3.

Meanwhile, when the identification information is received from the projector 100 (YES in step S5), the second controller 250 displays the first app screen 501 including the received identification information, on the touch panel 230 (step S7).

Next, the second controller 250 determines whether one of the projectors 100 whose identification information is displayed on the first app screen 501 is selected or not (step S8). When one of the projectors 100 whose identification information is displayed is selected (YES in step S8), the second controller 250 transmits a connection request to the selected projector 100 and wirelessly connects to the selected projector 100 (step S9). The projector 100 selected in step S8 is equivalent to a first display device.

Meanwhile, when one of the projectors 100 whose identification information is displayed is not selected (NO in step S8) and the selection field 505 for selecting another projector 100 than the projectors 100 in the first communication mode is selected, the second controller 250 wirelessly connects to the wireless network 10. The second controller 250 connects to the wireless network 10, using the SSID 265 and the first password 267. The second controller 250 acquires the identification information of the projector 100 operating in the second communication mode and connected to the wireless network 10 (step S10).

Next, the second controller 250 displays the second app screen 520 including the acquired identification information, on the touch panel 230 (step S11). The second controller 250 determines whether the projector 100 whose identification information is displayed on the second app screen 520 is selected or not (step S12).

When the projector 100 is not selected (NO in step S12), the second controller 250 waits until the projector 100 is selected. When the projector 100 is selected (YES in step S12), the second controller 250 displays the request screen 530 shown in FIG. 7 (step S13) and displays a password entry guide. When no password is entered (NO in step S14), the second controller 250 waits to start processing until a password is entered. The projector 100 selected in step S12 is equivalent to a third display device and a fourth display device.

When a password is entered (YES in step S14), the second controller 250 determines whether the entered password coincides with the second password 269 and thus performs authentication (step S15). When the entered password does not coincide with the second password 269, the second controller 250 determines that the authentication has failed (NO in step S15) and returns to step S13.

When the entered password coincides with the second password 269 and the authentication is successful (YES in step S15), the second controller 250 transmits a change request for the communication mode to the projector 100 selected in step S12 (step S16).

The second controller 250 determines whether or not a change notification notifying that the communication mode is changed to the first communication mode is received from the projector 100 to which the change request for the communication mode is transmitted (step S17). When the change notification is not received (NO in step S17), the second controller 250 displays an error indication (step S18) and returns to step S7.

When the change notification is received (YES in step S17), the second controller 250 displays the first app screen 501 shown in FIG. 8. On the first app screen 501, the identification information of the projector 100 from which the change notification is received is displayed. Subsequently, when the projector 100 whose identification information is displayed on the first app screen 501 is selected (YES in step S8), the second controller 250 transmits a connection request to the selected projector 100. The second controller 250 then wirelessly connects to the selected projector 100 (step S9).

When it is determined in step S3 that the connection mode is not the first connection mode (NO in step S3), the second controller 250 connects to the wireless network 10 (step S19). The second controller 250 connects to the wireless network 10, using the SSID 265 and the first password 267. The second controller 250 acquires the identification information of the projector 100 operating in the second communication mode and connected to the wireless network 10 (step S20).

Next, when the projector 100 is not selected (NO in step S21), the second controller 250 waits until the projector 100 is selected. When the projector 100 is selected (YES in step S21), the second controller 250 displays the entry screen for the IP address of the selected projector 100 and requests the entry of the IP address (step S22). The projector 100 selected in step S21 is equivalent to a second display device.

The second controller 250 determines whether the IP address is entered or not (step S23). When the IP address is not entered (NO in step S23), the second controller 250 waits until the IP address is entered.

Meanwhile, when the IP address is entered (YES in step S23), the second controller 250 transmits a connection request to the projector 100 of the entered IP address and wirelessly connects to the selected projector 100 (step S24).

5. Operations of Projector

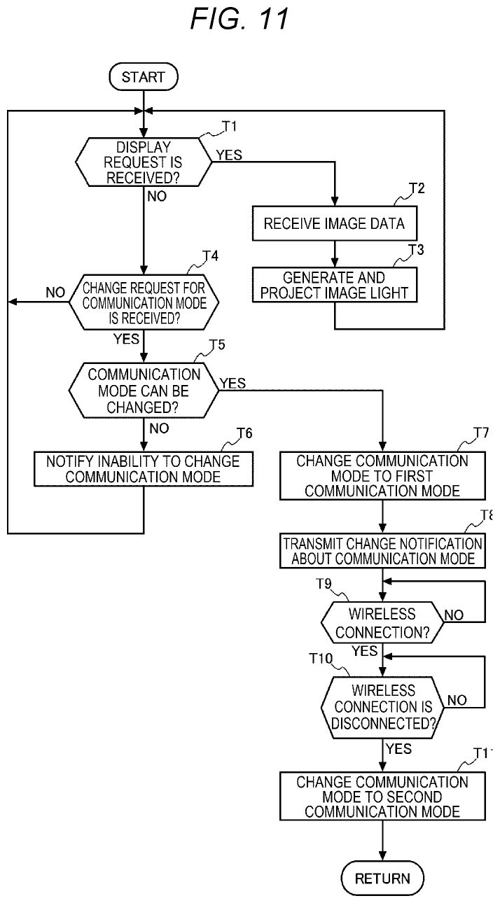

FIG. 11 is a flowchart showing operations of the projector 100.

The operations of the projector 100 will now be described with reference to the flowchart shown in FIG. 11.

The flowchart shown in FIG. 11 describes the operations of the projector 100 whose communication mode is set to be the second communication mode.

The first controller 150 determines whether a display request for an image is received or not (step T1). When the display request is received (YES in step T1), the first controller 150 transmits a display permission to the sender of the display request. Subsequently, the first controller 150 receives image data transmitted from the sender of the display request (step T2). The first controller 150 generates image light based on the received image data and projects the generated image light (step T3).

Meanwhile, when the display request is not received (NO in step T1), the first controller 150 determines whether a change request for the communication mode is received or not (step T4). When the change request for the communication mode is not received (NO in step T4), the first controller 150 returns to the determination of step T1.

When the change request for the communication mode is received (YES in step T4), the first controller 150 determines whether the communication mode can be changed or not (step T5). The first controller 150 determines whether or not it is a state where the communication mode can be changed, such as a state where image data is not received from any other device (step T5). When it is determined that the communication mode cannot be changed (NO in step T5), the first controller 150 notifies the requester of the change of the communication mode, of the inability to change the communication mode (step T6). Subsequently, the first controller 150 returns to the determination of step T1.

When it is determined that the communication mode can be changed (YES in step T5), the first controller 150 changes the communication mode from the second communication mode to the first communication mode (step T7). That is, the projector 100 operates as an access point and accepts an access from an IP address corresponding to the set IP address 163. After changing the communication mode, the first controller 150 transmits a change notification about the communication mode to the sender of the change request (step T8).

Next, the first controller 150 receives a request for wireless connection at the IP address corresponding to the set IP address 163 and determines whether a wireless connection to this requester is established or not (step T9). When the wireless connection to the requester is not established (NO in step T9), the first controller 150 waits until the wireless connection is established.

When the wireless connection to the requester is established (YES in step T9), the first controller 150 receives image data transmitted from this requester and generates image light based on the received image data. The first controller 150 projects the generated image light.

Next, the first controller 150 determines whether the wireless connection to the requester is disconnected or not (step T10). When the wireless connection is not disconnected (NO in step T10), the first controller 150 waits until the wireless connection is disconnected. When the wireless connection is disconnected (YES in step T10), the first controller 150 changes the communication mode from the first communication mode to the second communication mode (step T11) and returns to the determination of step T1.

6. Effects of Control Method for Display System

When the first connection mode is set, the information processing device 200 detects the projectors 100A and 100B accepting a connection request with the set IP address 263 stored in advance in the second storage 260, from among a plurality of projectors 100.

The information processing device 200 transmits a first connection request, which is a connection request using the set IP address 263, to the projector 100A or 100B.

When the second connection mode is selected, the information processing device 200 detects the projectors 100C and 100D connected to the wireless network 10, from among the plurality of projectors 100.

The information processing device 200 accepts the entry of the IP address in the wireless network 10 of the projector 100C or 100D selected from the projectors 100C and 100D connected to the wireless network 10.

The information processing device 200 transmits a second connection request, which is a connection request using the IP address in the wireless network 10, to the selected projector 100C or 100D.

Thus, when the information processing device 200 is set in the first connection mode, the information processing device 200 can be easily connected to the projector 100A or 100B accepting the connection request with the preset set IP address 263.

Meanwhile, when the information processing device 200 is set in the second connection mode, the information processing device 200 cannot be connected to the projector 100C or 100D unless the address in the wireless network 10 is entered.

Thus, switching between an easy connection mode to the projector 100 and a connection mode where security is maintained can be implemented. Therefore, the convenience for the user can be improved without causing deterioration in security.

When the projectors 100A and 100B are set in the first communication mode and accept a first connection request, the projectors 100A and 100B permit the first connection request.

Thus, when the projectors 100A and 100B accept a first connection request, this first connection request can be permitted.

When the projectors 100C and 100D are set in the second communication mode and accept a second connection request, the projectors 100C and 100D permit the second connection request.

Thus, when the projectors 100C and 100D accept a second connection request, this second connection request can be permitted.

When the information processing device 200 has accepted preset authentication information, the information processing device 200 requests the projector 100C or 100D selected from the projectors 100C and 100D connected to the wireless network 10 and set in the second communication mode, to change the communication mode to the first communication mode.

When requested to change the communication mode to the first communication mode, the selected projector 100C or 100D changes the communication mode from the second communication mode to the first communication mode.

Thus, as preset authentication information is inputted, the communication mode of the projectors 100C and 100D in the second communication mode can be changed from the second communication mode to the first communication mode and the projectors 100C and 100D can be easily connected to the information processing device 200.

When the first connection mode is set, the information processing device 200 displays the first app screen 501 where the identification information of the projector 100A or 100B is displayed.

When requested to display the identification information of the projector 100 connected to the wireless network 10, the information processing device 200 displays the second app screen 520 where the identification information of the projector 100 connected to the wireless network 10 is displayed.

When the projector 100C or 100D is selected on the second app screen 520, the information processing device 200 accepts preset authentication information.

When the information processing device 200 has accepted the preset authentication information, the information processing device 200 requests the projector 100C or 100D to change the communication mode to the first communication mode.

Thus, when the projector 100 to connect to is not included in the first app screen 501, the second app screen 520 where the identification information of the projector 100 connected to the wireless network 10 is displayed can be displayed.

Also, as preset authentication information is inputted, the communication mode of the projectors 100C and 100D in the second communication mode can be changed from the second communication mode to the first communication mode and the projectors 100C and 100D can be easily connected to the information processing device 200.

The projectors 100C and 100D in the second communication mode change the communication mode from the second communication mode to the first communication mode for the duration of a preset set time period.

Thus, since the communication mode is changed from the second communication mode to the first communication mode for the duration of the preset set time period, the information processing device 200 can be easily connected to the projector 100 only for the duration of this set time period.

7. Effects of Connection Method for Information Processing Device

When the first connection mode is set, the information processing device 200 detects the projectors 100A and 100B accepting a connection request with the set IP address 263 stored in advance in the second storage 260, from among a plurality of projectors 100.

The information processing device 200 transmits a first connection request, which is a connection request using the set IP address 263, to the projector 100A or 100B.

When the second connection mode is set, the information processing device 200 detects the projectors 100C and 100D connected to the wireless network 10, from among the plurality of projectors 100.

The information processing device 200 accepts the entry of the IP address in the wireless network 10 of the projector 100C or 100D selected from the projectors 100C and 100D connected to the wireless network 10.

The information processing device 200 transmits a second connection request, which is a connection request using the IP address in the wireless network 10, to the selected projector 100C or 100D.

Thus, when the information processing device 200 is set in the first connection mode, the information processing device 200 can be easily connected to the projector 100A or 100B accepting the connection request with the preset set IP address 263.

Meanwhile, when the information processing device 200 is set in the second connection mode, the information processing device 200 cannot be connected to the projector 100C or 100D unless the address in the wireless network 10 is entered.

Thus, switching between an easy connection mode to the projector 100 and a connection mode where security is maintained can be implemented. Therefore, the convenience for the user can be improved without causing deterioration in security.

When the information processing device 200 has accepted preset authentication information, the information processing device 200 requests the projector 100C or 100D selected from the projectors 100C and 100D connected to the wireless network 10 and set in the second communication mode, to change the communication mode to the first communication mode.

Thus, as preset authentication information is inputted, the projector 100 in the second communication mode can be changed to the first communication mode and the projector 100 in the second communication mode and the information processing device 200 can be easily connected to each other.

When the first connection mode is set, the information processing device 200 displays the first app screen 501 where the identification information of the projectors 100A and 100B is displayed.

When requested to display the identification information of the display device connected to the wireless network 10, the information processing device 200 displays the second app screen 520 where the identification information of the projectors 100C and 100D connected to the wireless network 10 is displayed.

When the projector 100C or 100D is selected on the second app screen 520, the information processing device 200 accepts preset authentication information.

When the information processing device 200 has accepted the preset authentication information, the information processing device 200 requests the selected projector 100C or 100D to change the communication mode to the first communication mode.

Thus, when the projector 100 to connect to is not included in the first app screen 501, the second app screen 520 where the identification information of the projector 100 connected to the wireless network 10 is displayed can be displayed.

Also, as preset authentication information is inputted, the communication mode of the projectors 100C and 100D in the second communication mode can be changed from the second communication mode to the first communication mode and the projectors 100C and 100D can be easily connected to the information processing device 200.

8. Effects of Program

When the first connection mode is set, the second processor 270 provided in the information processing device 200 detects the projectors 100A and 100B accepting a connection request with a preset address. The second processor 270 requests the detected projector 100A or 100B to establish a connection.

When the second connection mode is selected, the second processor 270 detects the projectors 100C and 100D connected to the wireless network 10.

The second processor 270 accepts the entry of the IP address in the wireless network 10 of the projector 100C or 100D selected from the projectors 100C and 100D connected to the wireless network 10.

The second processor 270 requests the selected projector 100C or 100D to establish a connection.

Thus, when the information processing device 200 is set in the first connection mode, the information processing device 200 can be easily connected to the projector 100 accepting the connection request with a preset set address.

Meanwhile, when the information processing device 200 is set in the second connection mode, the information processing device 200 cannot be connected to the projector 100 connected to the wireless network 10 unless the address of the projector 100 connected to the wireless network 10 is entered.

Thus, an easy connection to the projector 100 and a connection where security is maintained can be both implemented. Therefore, the convenience for the user can be improved.

The foregoing embodiment is a preferred embodiment of the present disclosure. However, the present disclosure is not limited to the foregoing embodiment and can be implemented with various modifications without departing from the spirit and scope of the present disclosure.

For example, in the foregoing description of the embodiment, the second password 269 set by the system manager is stored in the second storage 260 of the information processing device 200. The information processing device 200 executes password authentication when changing the communication mode of the projector 100 from the second communication mode to the first communication mode. The second password 269 may be stored in the projector 100 and the information processing device 200 may transmit an entered password when transmitting a change request for the communication mode to the projector 100. The projector 100 takes out the password from the received change request, determines whether this password coincides with the second password 269 or not, and thus performs password authentication. When the password authentication is successful, the projector 100 changes the communication mode from the second communication mode to the first communication mode according to the change request.

In the configuration where the second password 269 is stored in the projector 100, the user may set the second password 269.

First, the user manually enters the IP address of the projector 100 and wirelessly connects the information processing device 200 to the projector 100 in the second communication mode. The projector 100 requests the information processing device 200 connected by the manual entry of the IP address, to set a password and an ID. The information processing device 200 transmits a password and an ID set by the user, to the projector 100. The projector 100 stores the received password and ID in the first storage 160. At this point, the projector 100 stores the password received from the information processing device 200, as the second password 269.

The functional units of the projector 100 and the information processing device 200 shown in FIG. 1 represent a functional configuration and are particularly not limited to any specific form of installation. That is, individual pieces of hardware corresponding to the individual functional units need not necessarily be installed. Of course, a configuration where a single processor executes a program and thus implements a plurality of functional units can be employed. A part of the functions implemented by software in the embodiment may be implemented by hardware. Also, a part of the functions implemented by hardware may be implemented by software. The specific detailed configuration of each of the other parts of the projector can be arbitrarily changed without departing from the spirit and scope of the present disclosure.

When implemented by the computer provided in the information processing device 200 or the computer provided in the projector 100, the control method for the display system, the connection method for the information processing device, and the program can also be configured in the form of a recording medium in which a program to be executed by the computer is recorded or a transmission medium transmitting this program. As the recording medium, a magnetic or optical recording medium, or a semiconductor memory device can be used. Specifically, a portable recording medium such as a flexible disk, an HDD (hard disk drive), a CD-ROM, a DVD, a Blu-ray disc, a magneto-optical disk, a flash memory or a card-type recording medium, or a fixed recording medium may be employed. The recording medium may also be a non-volatile storage device such as a RAM, a ROM or an HDD that is an internal storage device provided in a server device. Blu-ray is a registered trademark.

What is claimed is:

1. A connection control method comprising:
when an information processing device is in a first connection mode,
detecting, by the information processing device, a first display device which accepts a connection request with a preset address, among a plurality of display devices, and
transmitting, by the information processing device, a first connection request using the preset address to the first display device; and
when the information processing device is in a second connection mode,
detecting, by the information processing device, at least one display device connected to a network, among the plurality of display devices,
accepting, by the information processing device, an operation of selecting a second display device from among the at least one display device connected to the network,
accepting, by the information processing device, an input of an address in the network of the second display device, and
transmitting, by the information processing device, a second connection request using the address in the network to the second display device.

2. The connection control method according to claim 1, further comprising:
permitting, by the first display device, the first connection request, when the first display device is in a first communication mode and accepts the first connection request.

3. The connection control method according to claim 2, further comprising:
permitting, by the second display device, the second connection request, when the second display device is in a second communication mode that is different from the first communication mode, and accepts the second connection request.

4. The connection control method according to claim 3, wherein
a communication mode of the at least one display device connected to the network is the second communication mode, and
the connection control method further comprises:
accepting, by the information processing device, an operation of selecting a third display device from among the at least one display device connected to the network; and
transmitting, by the information processing device, a change request that requests a change from the second communication mode to the first communication mode, to the third display device, when accepting authentication information.

5. The connection control method according to claim 4, further comprising:
changing the communication mode of the third display device from the second communication mode to the first communication mode when receiving the change request.

6. The connection control method according to claim 4, further comprising:
when the information processing device is in the first connection mode,
displaying, by the information processing device, a first screen including identification information of the first display device, and
displaying, by the information processing device, a second screen including identification information of the at least one display device connected to the network, when accepting a request to display the identification information of the display device connected to the network, and wherein
the accepting the operation of selecting the third display device includes accepting an operation of selecting the third display device on the second screen.

7. The connection control method according to claim 3, wherein
a communication mode of the plurality of display devices is the second communication mode, and
the plurality of display devices change the communication mode from the second communication mode to the first communication mode for a duration of a set time period.

8. An information processing device comprising:
a communication interface; and
at least one processor executing
in a first connection mode,
detecting a first display device which accepts a connection request with a preset address, among a plurality of display devices, and
transmitting a first connection request using the preset address to the first display device via the communication interface, and
in a second connection mode,
detecting at least one display device connected to a network, among the plurality of display devices,
accepting an operation of selecting a second display device from among the at least one display device connected to the network,
accepting an input of an address in the network of the second display device, and
transmitting a second connection request using the address in the network to the second display device via the communication interface.

9. The information processing device according to claim 8, wherein
a communication mode of the at least one display device connected to the network is a second communication mode, and
the at least one processor further executes
accepting an operation of selecting a third display device from among the at least one display device connected to the network; and
transmitting a change request that requests a change from the second communication mode to a first communication mode, to the third display device, when accepting authentication information.

10. The information processing device according to claim 9, further comprising:
a display panel, wherein
the at least one processor further executes
when in the first connection mode,
displaying a first screen including identification information of the first display device, on the display panel, and
displaying a second screen including identification information of the at least one display device connected to the network, on the display panel, when accepting a request to display the identification information of the at least one display device connected to the network, and wherein
the accepting the operation of selecting the third display device includes accepting an operation of selecting the third display device on the second screen.

11. A non-transitory computer-readable recording medium storing a program, the program causing an information processing device to execute:
in a first connection mode,
detecting a first display device which accepts a connection request with a preset address, among a plurality of display devices, and
transmitting a first connection request using the preset address to the first display device; and
in a second connection mode,
detecting at least one display device connected to a network, among the plurality of display devices,
accepting an operation of selecting a second display device from among the at least one display device connected to the network,
accepting an input of an address in the network of the second display device, and
transmitting a second connection request using the address in the network to the second display device.
